(19) United States
(12) Patent Application Publication
(10) Pub. No.: US 2005/0137921 A1
(43) Pub. Date: Jun. 23, 2005

(54) Method for evaluating the costs and benefits of environmental construction projects

(76) Inventor: Shahram Paul Shahriari, Cape Coral, FL (US)

Correspondence Address: SMITH, GAMBRELL & RUSSELL, LLP;SUITE 3100, PROMENADE II, 1230 PEACHTREE STREET, N.E., ATLANTA, GA, 30309-3592, US

(21) Appl. No.: 11/021,425

(22) Filed: Dec. 22, 2004

Related U.S. Application Data
(60) Provisional application No. 60/532,285, filed on Dec. 22, 2003.

(51) Int. Cl. G06F 17/60

(52) U.S. Cl. 705/7

(57) ABSTRACT

A method for evaluating environmentally-friendly construction projects according to a multiple certification levels to determine which certification level is cost effective for the environmentally-sound construction project. The method establishes a construction rating system used in analyzing the construction project and having multiple certification levels corresponding to a number of credits that may be earned with specific improvements. Using a central processing unit having a database with the various credits, the user will select the particular credits corresponding with the construction improvements to be implemented in the construction project. The costs and benefits of the project, both initially and during the life of the project, will be calculated using interest values entered by the user or stored in the database. The costs and benefits of the construction project will then be compared over the lifetime of the project for the user to select the construction improvements meeting the desired certification levels.

### CROSS-REFERENCE TO RELATED APPLICATIONS

The present application claims priority to U.S. Provisional Patent Application No. 60/532,285, filed on Dec. 22, 2003, which is incorporated herein by reference.

### FIELD OF THE INVENTION

The present invention generally relates to a method for evaluating the benefits of environmental improvements in such construction projects, and more specifically, to a method for computing and establishing the costs and related benefits concerning environmental improvement projects in new and established construction projects, and even more specifically, to providing a software design to assist users in analyzing the cost benefit of attaining various rating levels under the LEED rating system and make corresponding decisions on environmental design.

### DESCRIPTION OF RELATED ART

Environmentally conscious construction is an important concept that is continuously being developed. It has been estimated that the constructing, using and tearing down of buildings accounts for more than forty percent of the use of energy through the world. As a result, it is important to have environmental conscious construction (also referred to as “green buildings”) to improve energy use and related aspects.

To assist in rating environmentally conscious buildings, the U.S. Green Building Council (“USGBC”), has provided a certification system to determine whether new commercial construction is environmentally friendly, or “green.” To help analyze and recognize a builder's efforts in constructing green buildings, the rating system known as LEED (Leadership in Energy and Environmental Design) Green Building Rating System has been developed. LEED is a voluntary, consensus-based national standard for developing high-performance, sustainable buildings that are environmentally responsible and efficient. LEED standards are currently available for new construction and major renovation projects (NC); existing building operations (EB); commercial interiors projects (CI); and core and shell projects (CS).

More particularly, LEED is a an assessment rating system that has requirements that are tied to credits within the rating system. The requirements tell a user how a project can be a more environmentally friendly building through design and construction. To achieve the credit, most projects have to change design or engineering methods to make the building better. In performing this type of improvement, there are typically costs and certain credits provide long term benefits due to achievement. For example, a credit may require Optimized Energy Performance beyond the minimum requirements of a state or local code. Thus, the project manager might spend $200,000 additional for added insulation, but save $35,000 per month in energy costs to heat and cool the building. This tool takes all credit requirements and analyze cost and benefit per credit.

LEED is a self-certifying system, designed for rating new and existing commercial, institutional, and multi-family residential buildings. It contains prerequisites and credits in six categories or topic areas: sustainable site planning, improving energy efficiency, conserving materials and resources, embracing indoor environmental quality, safeguarding water, and innovation and design process. Moreover, LEED is a point-based rating system having four rating levels: Certified, Silver, Gold, and Platinum. That is, points are earned for building attributes considered environmentally beneficial. Thus, LEED has quantified most of the “green credits” to assist in analysis. The more points that are attained using the LEED rating system, the higher the company's rating and rating level.

As an example, the LEED system provides one credit to a construction plan if 5% of the building materials are from salvaged materials. The present version of LEED provides 69 possible points in the six topic areas, each topic area having a statement of associated goals. As previously mentioned, these areas include the following: Sustainable Sites (minimize storm water run-off, encourage car pooling and bicycling, increase urban density and increase green space); Water Efficiency (eliminate site irrigation, reduce water consumption, minimize or treat wastewater); Energy and Atmosphere (reduce building energy consumption, use renewable energy, eliminate ozone-depleting chemicals, commission building systems); Material and Resources (minimize construction waste, re-use existing building facade, use recycled and salvaged materials, use renewable construction materials); Indoor Environmental Quality (incorporate day lighting, use low-gassing materials, provide operable windows and occupant control of work space, improve delivery of ventilation air); and Process (use a LEED accredited professional, greatly exceed the requirements of a credit, incorporate innovative environmental features not covered in other areas).

Thus, LEED was created to define “green building” by establishing a common standard of measurement, promote integrated, whole-building design practices recognize environmental leadership in the building industry, stimulate green competition, raise consumer awareness of green building benefits, and transform the building market. LEED provides a substantially complete framework for assessing building performance and meeting sustainability goals. Based on well-founded scientific standards, LEED emphasizes state of the art strategies for sustainable site development, water savings, energy efficiency, materials selection and indoor environmental quality. LEED recognizes achievements and promotes expertise in green building through a comprehensive system offering project certification, professional accreditation, training and practical resources.

Architects and engineers can pick and choose the credits that are most appropriate to their specific project to achieve the desired LEED rating. With respect to performance levels identified above for new construction projects, the architect achieves “Certified” by acquiring 26 to 32 credits/points, “Silver” by acquiring 33 to 38 credits/points, “Gold” by acquiring 39 to 51 credits/points, or “Platinum” by acquiring 52 to 69 credits/points. However, these credits/points may vary according to the construction project being performed. The benefit in receiving one of these certifications is that the company establishes itself as a leader in the environmentally-friendly construction sector, validates achievement through third-party review of the construction project, helps the company to qualify for governmental incentives, and it provides rewards that celebrate the achievement.

Despite these benefits, one of the most typical concerns that people have with “green” buildings are that the cost too much for the value of the return. While some industry experts estimate that environmentally safe construction can cost ten percent more than regular construction projects, studies have shown that the green features of buildings will typically pay for themselves within a few years. The savings come in the form of lower energy and water bills and higher worker productivity. For example, green buildings may maximize the use of natural light, or that may contain carpets or other flooring materials that do not give off unpleasant chemical odors.

Even with lower long-term costs, builders must still be convinced of the benefits of the investment in green buildings. This is generally because company officials in charge of authorizing new buildings and building repairs have a fixed budget for up-front costs, no matter what the eventual lifetime savings.

Thus, while the LEED systems described above provides a means for quantifying the environmentally benefits a particular design for a building, it fails to show the industry the immediate and long term benefits of “green” buildings and construction. Consequently, a method is needed for analyzing not only this information as to whether a construction project meets the requirements of being environmentally friendly, but also the various costs that are involved in implementing environmentally sound solutions to construction problems over a period of time, such that the user is able to determine and acknowledge the long term benefits of the project and consequently invest wisely in the construction projects.

### BRIEF SUMMARY OF THE INVENTION

The present invention provides a method for evaluating environmentally-friendly construction projects according to a multiple certification levels to determine which certification level is cost effective for the environmentally-sound construction project. The process initially establishes a construction rating system to be used in analyzing the construction project, with the present method relying on the LEED Green Building Rating System. This construction rating system has multiple certification levels (Certified, Silver, Gold, or Platinum) corresponding to a number of credits that may be earned with specific improvements. Thus, using a central processing unit having a database of the various credits, the user will select the particular credits corresponding with the construction improvements to be implemented in the construction project as desired or as required. The costs and benefits of the construction project, both initially and during the life of the project, will then be calculated using interest values entered by the user or stored in the database. The costs of the construction project will then be compared with the benefits of the construction project over the lifetime of the project, such as through a flow chart diagram, thereby allowing the user to select the construction improvements that matching the desired certification levels of the construction rating system.

### BRIEF DESCRIPTION OF THE VIEWS OF THE DRAWINGS

FIG. 1 is a flowchart illustrating a method of analyzing method for evaluating the costs and benefits of environmental construction projects of the present invention;

FIG. 2 is a flowchart illustrating the method of selecting a type of construction;

FIG. 3 is a flowchart illustrating the method for selecting a rating system;

FIG. 4 is a flowchart illustrating the method for calculating the cost impact of a construction project;

FIG. 5 is a flowchart illustrating the method for calculating the impact of benefits of an environmentally friendly construction project;

FIG. 6 is a block diagram of a system used to implement the method of the present invention;

FIG. 7 is a flowchart illustrating the process of selecting a project and corresponding rating system;

FIG. 8 is a flowchart illustrating the process of selecting the proper credit intent and credit requirement for a construction project;

FIGS. 9a-9f are illustrations of a credit savings calculator of the present invention;

FIG. 10 is a spreadsheet generated using the method of the present invention, said spreadsheet illustrating the costs and benefits of construction projects under four rating systems;

FIG. 11 is a flow diagram of the data obtained through the method of the present invention.

### DETAILED DESCRIPTION OF THE INVENTION

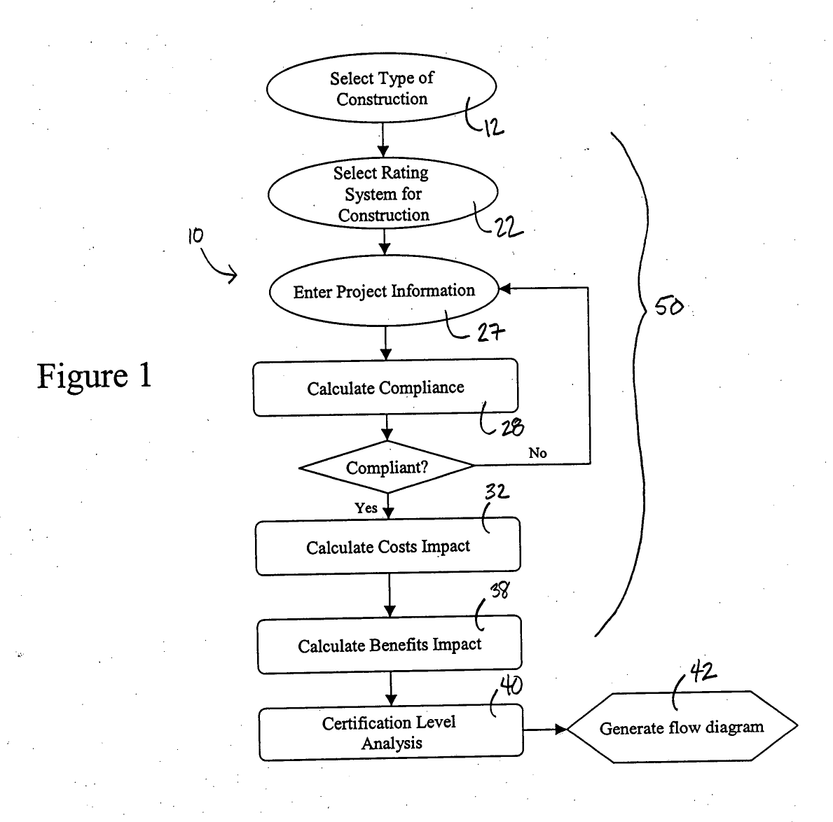

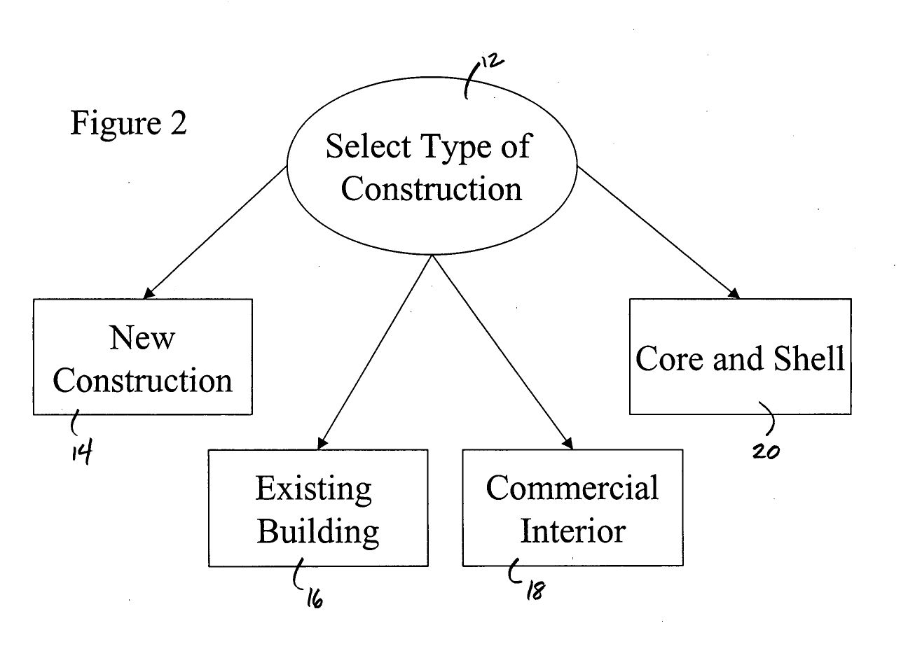

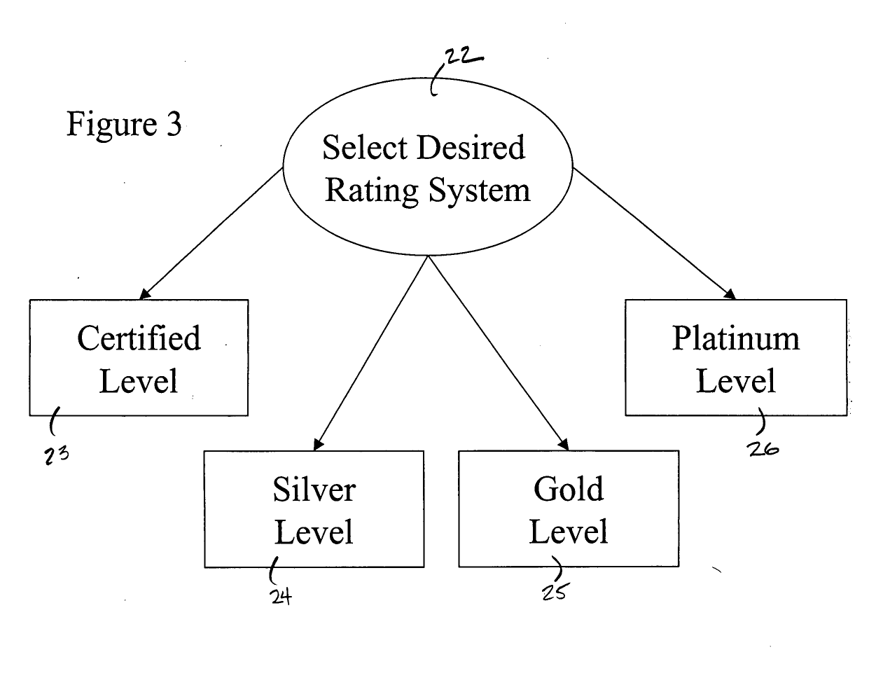

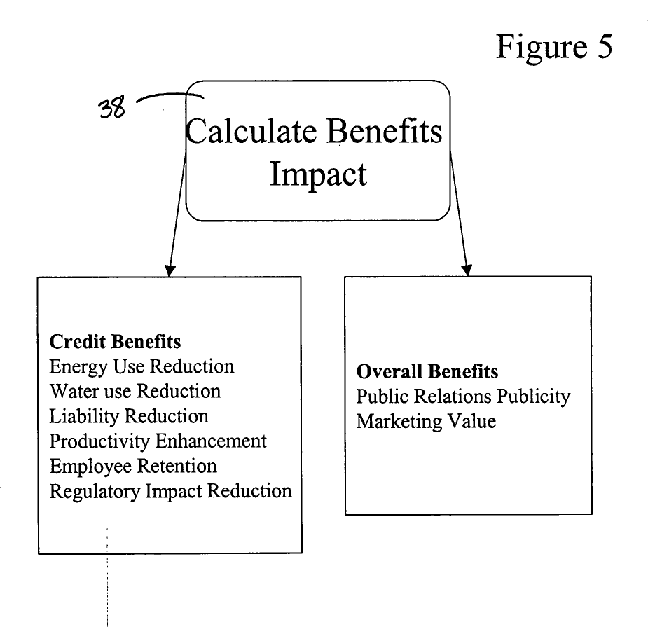

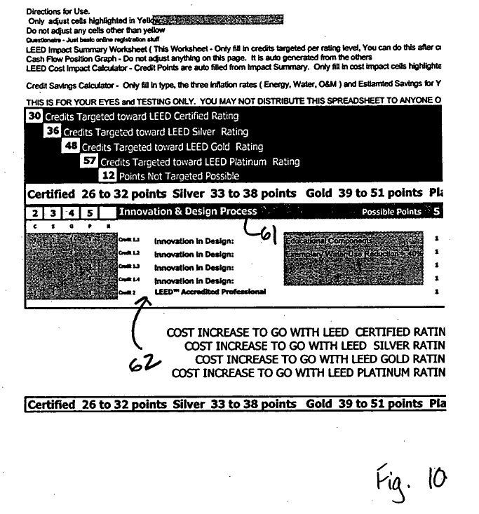

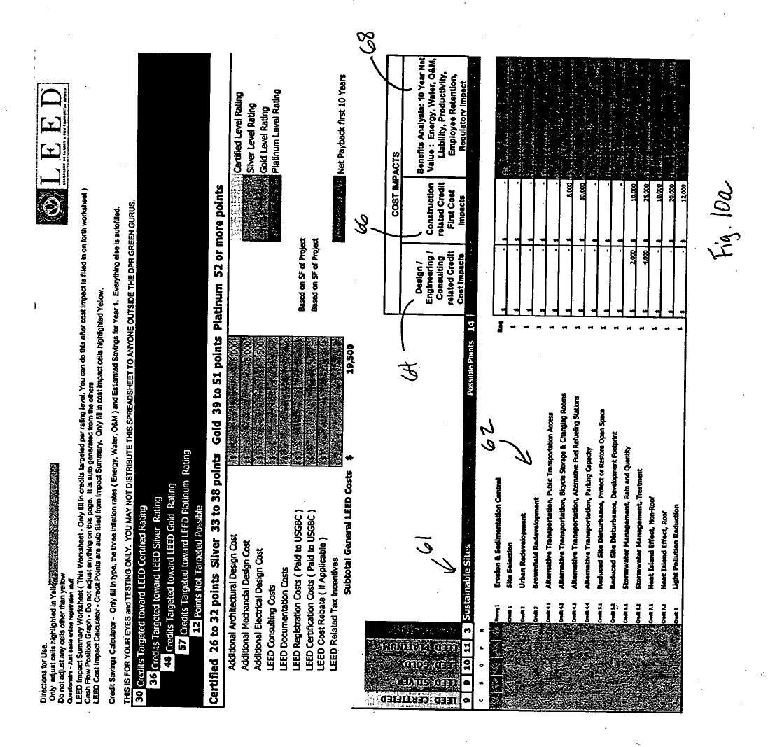

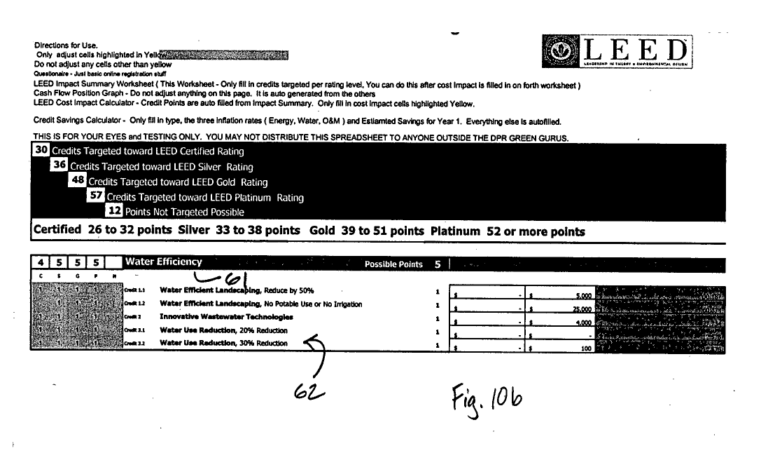

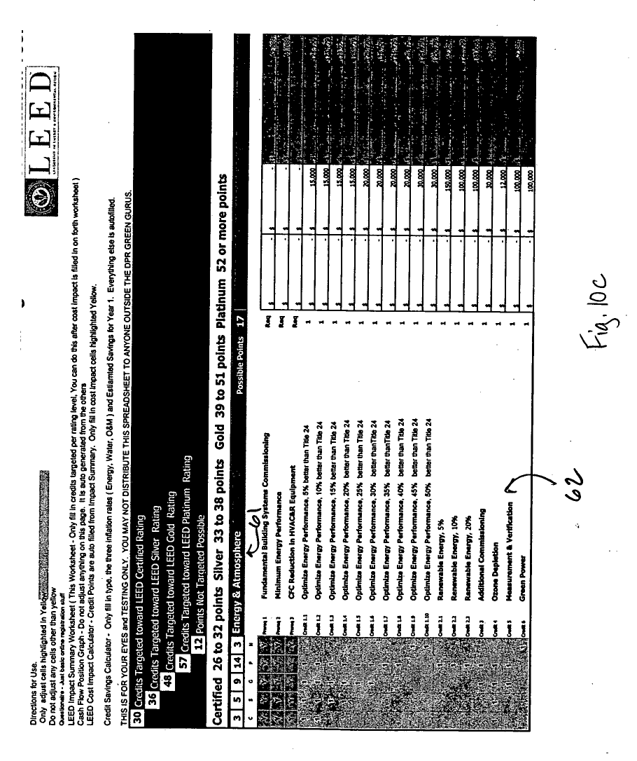

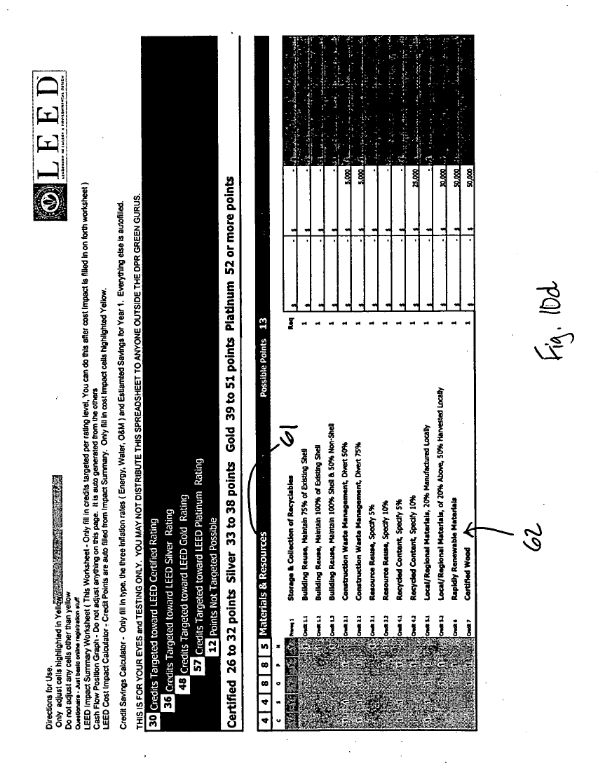

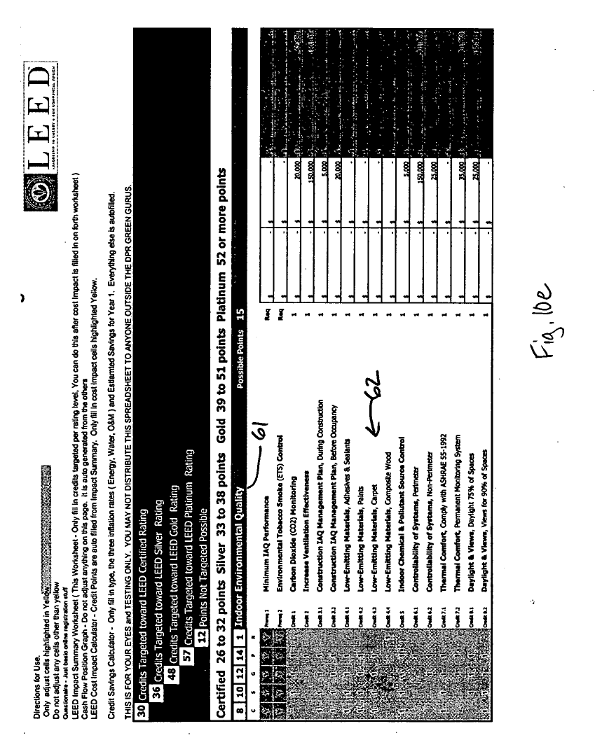

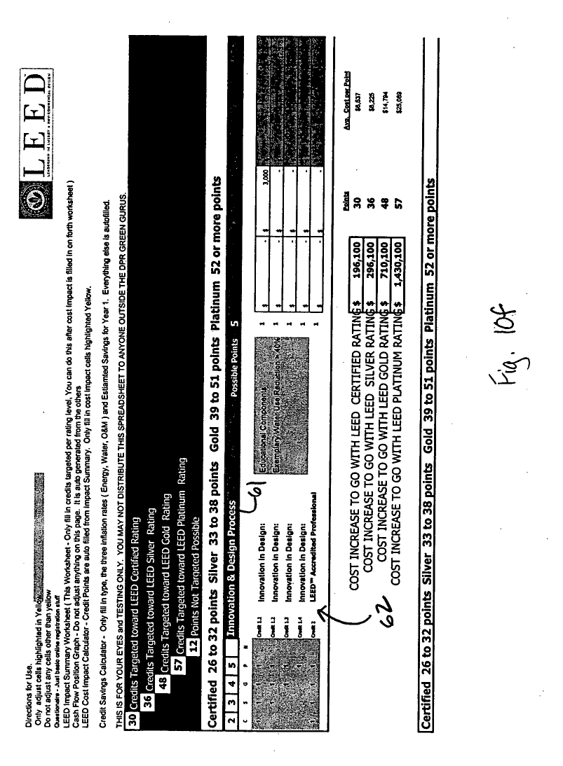

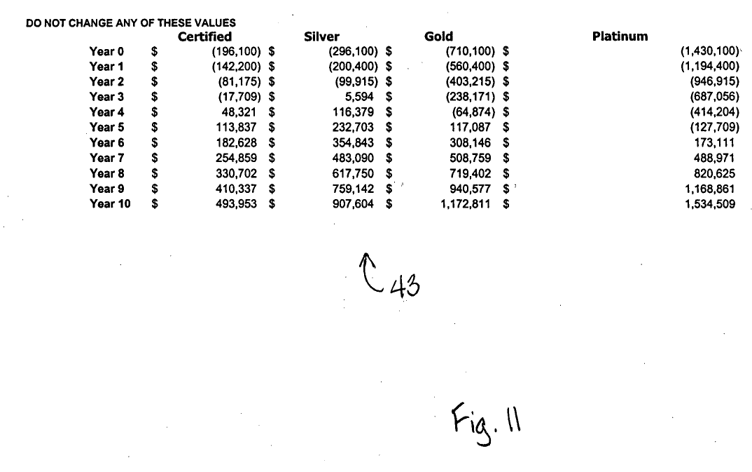

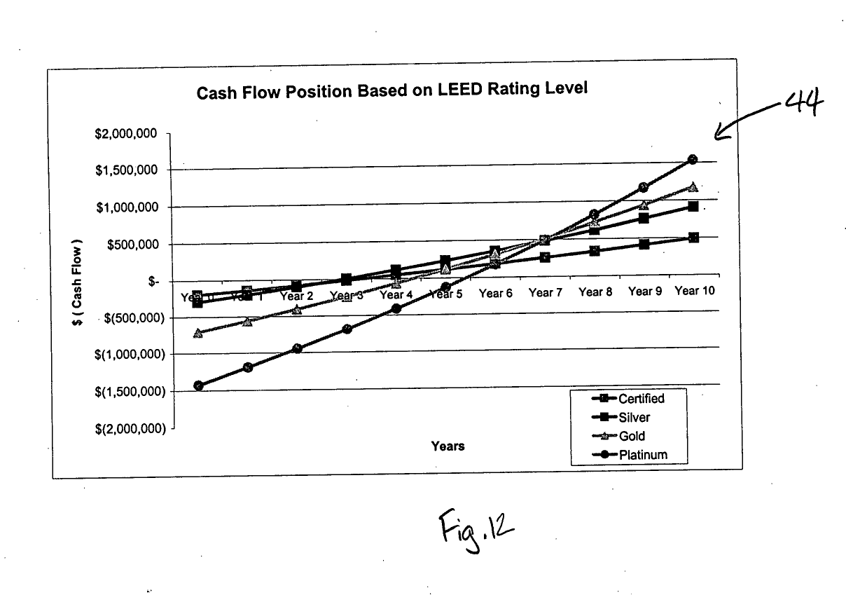

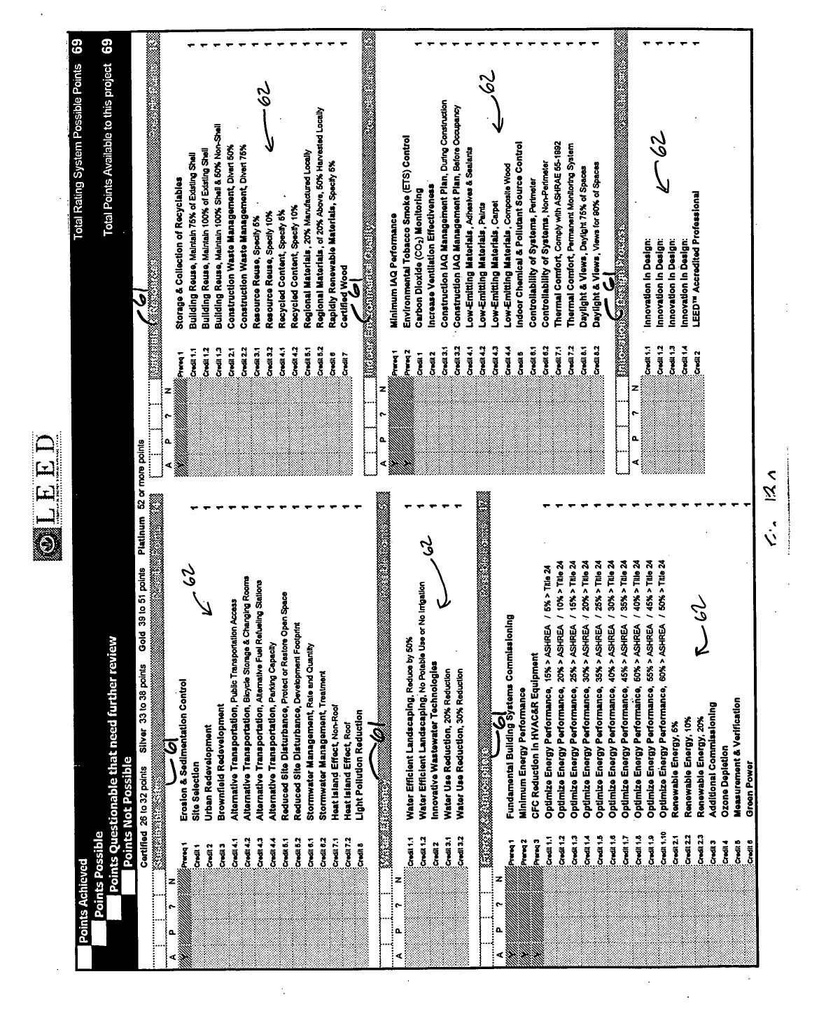

Referring now to FIGS. 1-6, a method for evaluating the benefits of environmental improvements in a variety of construction projects 10 is illustrated. The method of the present invention begins by a user 8 selecting the appropriate type of construction 12 that is to be performed from a variety of options, such as new construction 14, construction to existing buildings 16, commercial interiors 18, or core and shell construction 20. Once the type of construction has been selected 12, the user 8 will select which rating system 22 is to be used according to the user's desired results. As noted above, various rating systems 100 may be used to determine rank the environmental benefits of a project. One system 100 that is described and used in conjunction with the present invention has been labeled under the trademark LEED (Leadership in Energy and Environmental Design) Green Building Rating System, which is a system 100 that rates environmental projects at various levels. Specifically, environmental projects are labeled as Certified 23, Silver 24, Gold 25, or Platinum 26 according to the number of credits/points achieved by environmentally-sound construction improvements (see FIGS. 3 and 9a-9f).

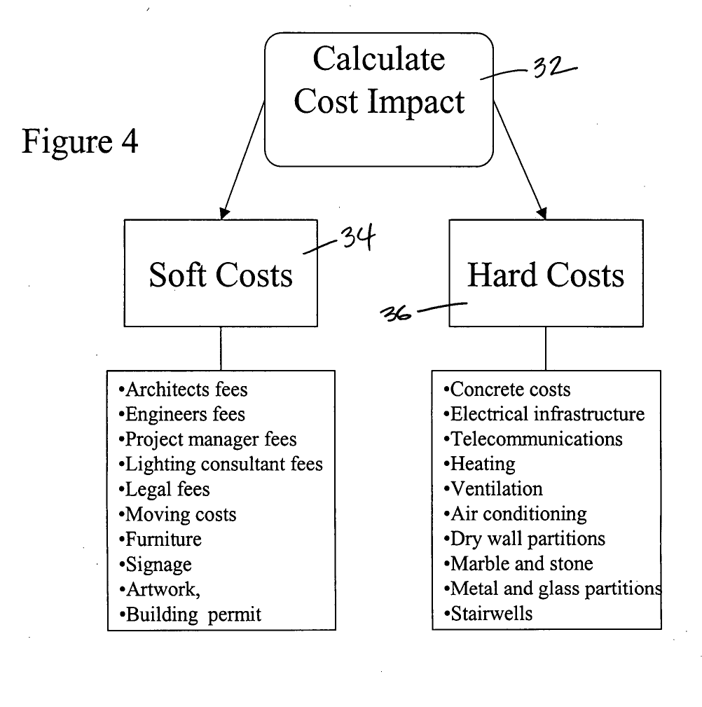

Referring to FIG. 1, once the rating system 22 has been chosen, the user 8 will start the process for determining the order of magnitude cost impacts for each credit corresponding to improvements performed. Looking to FIG. 4, the step “Calculate Costs Impact” 32 may review both the soft costs 34 and the hard costs 36 for each construction project. In general, hard costs 36 relate to actual improvements to the real property and include construction costs such as walls, heating, ventilation and air conditioning systems. A partial list of hard construction costs 36 would include concrete costs, electrical infrastructure, telecommunications infrastructure, heating, ventilation, air conditioning systems, dry wall partitions, ceilings, marble and stone, metal and glass partitions, stairwells, elevators and escalators, light fixtures, architecture metal and glass, architectural woodwork, flooring, sprinkler systems, plumbing systems and infrastructure, wood and metal doors, other hardware. On the other hand, soft costs 34 relate to matters such as professional fees, furniture and other items that are generally intangible, short-lived or movable. A partial list of soft construction costs 34 include architects fees, engineers fees, project manager fees, lighting consultant fees, other consultant fees, legal fees, moving costs, furniture, signage, interest/financing costs artwork, and building permit and filing fees.

This soft construction costs 34 count the general costs for just doing a LEED Certified Project. There are fixed cost from the USGBC and then there are typically additional up front costs charged to the project by team members for doing a LEED Certified project. The section that is filled out by the users 8 will also have five user 8 defined fields to incorporate additional changes. Also, any rebates from local municipalities and utilities will be included in the determination of costs. With respect to the process of the present invention, the soft costs 34 generally will not be included in the analysis of the cost impact of the “green” construction. However, the hard costs 36 are used for calculating the cost for attaining “green” credits as defined by LEED, which will be used in a comparison with benefits of the construction. Therefore, each and every possible credit is to be analyzed in this section.

The next step is to “Calculate the Impact of Benefits” 38, in which the user 8 determines the financial benefits for achieving any particular green credit within the chosen rating system 20. The user 8 is prompted with various perceived benefits 62 for the particular credit, and will then be able to choose the credits and corresponding benefits applicable for the particular project. The process for calculating benefits 38 may have a predetermined list of benefits that are associated with each green credit for a chosen rating system 22, but additional green credits may be added as so desired by the user 8. In any case, each potential benefit is provided with a relative cost value and a benefit value that may change over time.

An example of the step of calculating benefits impact 38 is a photovoltaic system to generate solar electricity for a building, which will provide a reduction in peak demand worth $25,000 year, and the user 8 chose a 5% energy inflation rate. The computer or system 100 will calculate the value of the benefit for every year from Year 1 to Year 50 in the life of the building using the initial value and the adjusted value over the specific period. The user 8 will also be asked whether or not the benefit or system 100 chosen for credit attainment has a life cycle. In the example of the photovoltaic system 100, it has a life span of only 20 years. Therefore, the process will only calculate the benefit for the first 20 years.

After the cost of a project is established and the benefits of the particular rating system are determined, the user 8 will then be able to perform a certification level analysis 40 and decide which green credits provide the greatest benefit for the particular construction project. That is, the user 8 will be able to decide which credits fit the desired cost and provide the best benefits over the long term for a particular construction project. At the same time, the user 8 will be able to monitor the green credits provided through the environmental project to assure the user 8 that the improvements meet the criteria for the desired rating system level (i.e., Platinum 26, Gold 25, Silver 24 or Certified 23 rating systems).

As the user 8 picks certain credits for each rating level, the central processing unit or computer 100 will calculate the total Day 0 costs upfront for attaining all the green credits for the particular rating system level. A payback/benefits subtotal for the user 8 will additionally be displayed. For example, the Day 0 costs for the Certified level 23 may only be $100,000, while the Gold level 25 may be $600,000, and this will be displayed to the user 8 on a computer monitor or printed document. In addition, the ten year benefit total will also be provided at this point. For example, the ten-year benefit for the Certified level 23 may show as $56,000, but the ten-year benefit for the Gold level 25 may show as $1,200,000. Thus, in this example, the user 8 will see that the smaller initial investment produces a return that is a small fraction of the initial cost, while the larger initial investment produces a return of twice the invested amount over a period of ten years. Thus, the user 8 will be able to compare the costs for each level versus the benefits acquired through the benefits of making the improvements provided at that level, and the user 8 will be able to monitor these improvements along a timeline of a length as chosen by the user 8.

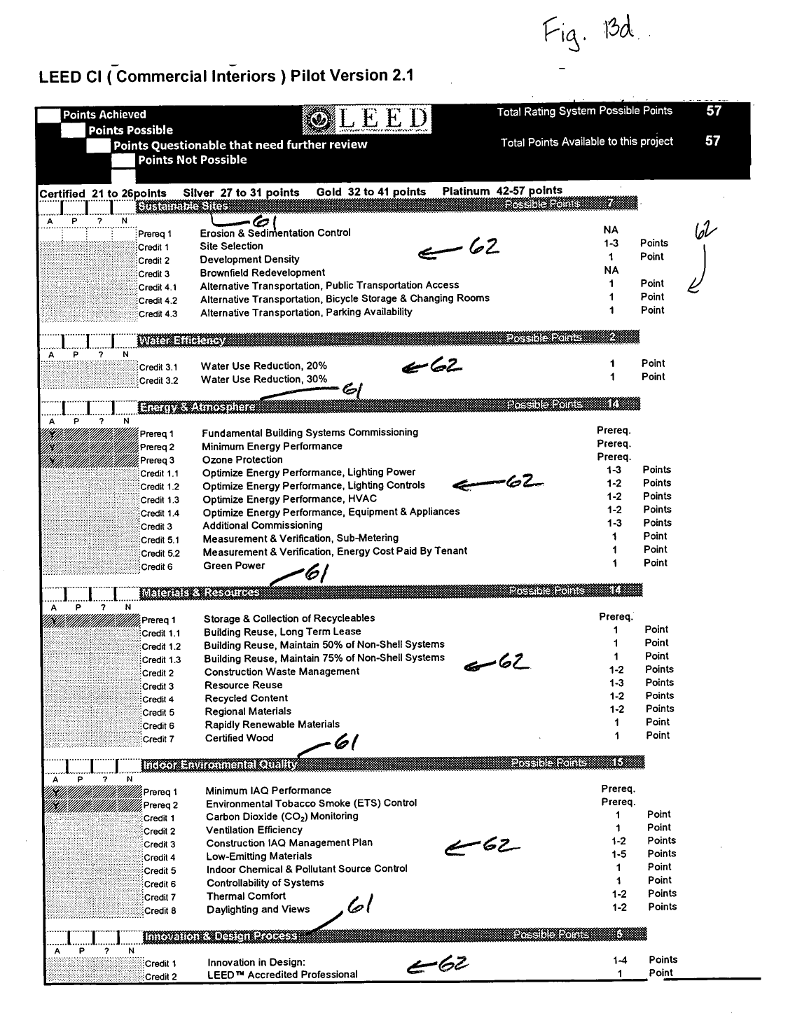

The process of the present invention further provides detailed feedback through the step 42 of generating a cash flow diagram 44 using the data computed for each rating level shown in the computed data spreadsheet 43 in FIG. 11. Specifically, the computed data spreadsheet 43 is obtained through the calculations of the system 100, and the cash flow diagram 44 (as illustrated in FIG. 12) is generated for the user 8 using this information. The cash flow diagram 44 is used to illustrate the returns on the “green” investment. The feedback may come in the form of a graph (as shown in FIG. 12) or chart that clearly illustrates the costs and benefits involved in the project. In the present example shown in FIG. 12, the cash flow diagram 44 shows the upfront cost for the construction project as well as the projected costs until the end of the life of the improvement. This allows the user 8 to see the initial outlay, the “break even” point, and the last date for return, as well as all points in between.

Looking at FIGS. 9a-9f, it should be noted that the method of the present invention will allow the user 8 to input the estimated or projected numbers 63 into the computer 100, such as the energy inflation rate, water inflation rate, operation cost inflation rate, maintenance cost inflation rate, liability cost inflation rate, productivity enhancement inflation rate, employee retention inflation rate, and regulatory impact inflation rate, among other costs (see FIG. 9a). These projected numbers 63 can therefore be amended by the user 8 as needed to accurately depict the projected costs entailed, and will affect the results as shown in the cash flow diagram 44 (see FIG. 12), as described herein.

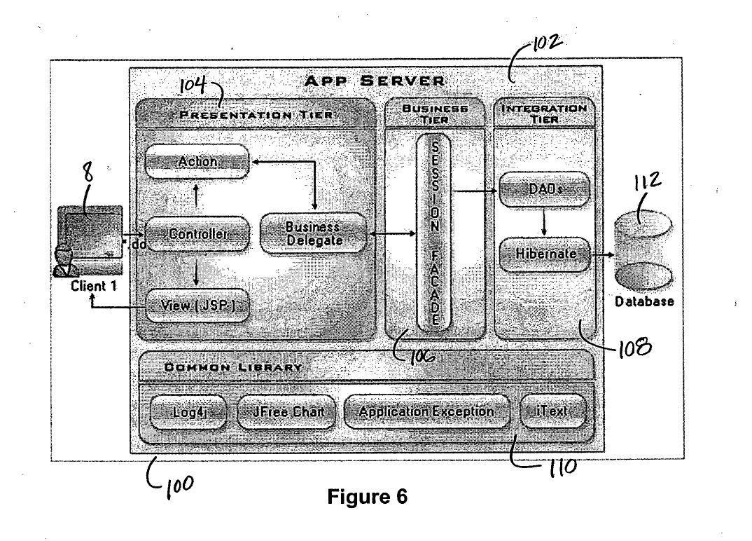

Looking again to FIG. 6, an architecture or block diagram of the system 100 used to control the method of the present invention is illustrated. Specifically, the user 8 or client is able to access an application server 102 that is operated using a central processing unit 100 or related computing device. The application server 102 is a conventional server that may easily be analyzed as having four components: a presentation tier 104, a business tier 106, an integration tier 108, and a common library 110. Furthermore, a database 112 is accessible to the application server 102, with the database 112 storing information concerning the various construction projects, rating systems, and other information used to determine the best construction option for a particular client 8.

The LEED system analysis tool of the present invention enables design professionals and construction management firms to analyze the cost benefits of attaining various rating levels under the LEED rating system and making a fact-based, financially sound decision on environmental design. The tool can be broadly classified into four sub-modules, which are (1) Registration and authentication; (2) Administration; (3) Project Evaluation; and (4) Reports. For purposes of the present application, the process described in the Project Evaluation and Reports sub-modules are described in greater detail herein.

Concerning Registration, Authentication and Administration, the system administrator can only access the registration process. Every user 8 can register their details in the system 100 or computer, and the system administrator authenticates the register users 8 for accessing the system 100. The system administrator manages account information and can update the credit information and payment information for the user 8. The user 8 fills the user name, firm name, position, address, email, phone, fax, and selects one of two options (For Trial/For License). If the license option is selected, the user 8 will enter the Number of Licenses desired and submit the request. A licensed user may then authorize a selected number of guest users to view the project information and reports. If the user 8 selects Trial option, the user 8 can access the system 100 with limited functionalities and will have only one user 8 license for the trial period after submitting. The Guest user 8 can start accessing the system 100 after registration, while a licensed user 8 has to wait for the system administrator to confirm payment information to start using system 100.

The steps comprising project evaluation 50 as illustrated in FIGS. 1, 7 and 8 include the following: selecting a rating system 22, entering project information 27, calculating compliance 28; calculating cost impact 38, including design cost impact and construction cost impact; and calculating the credit benefit 40. Using these steps, the system 100 is able to provide the following summaries: credit cost summary, credit benefit summary, credit impact summary, and credit status summary.

In evaluating a particular construction project, it is important to note that each individual project is typically associated with six categories, including sustainable sites (see FIG. 9a), water efficiency (see FIG. 9b), energy and atmosphere (see FIG. 9c), materials and resources (see FIG. 9d), indoor environmental quality (see FIG. 9e), and innovation and design process (see FIG. 9f). These categories provide a variety of factors for environmentally friendly construction projects to be analyzed. In the illustrated embodiment, the projects have a total value of sixty-nine credits or points, although this may be altered as new projects with potential new environmental projects. The user 8 inputs the data concerning a specific construction project 23, such that the present invention is able to summarize the necessary information in summary sheets.

The step of calculating compliance 28 is to provide simple calculations based on the credit compliance. That is, after the user has entered project information and requirements, the system 100 will check the number of green credits to confirm that they are as planned. If they are correct, then the system may proceed to calculate the associated costs 32. If the number is incorrect or not sufficient for the associated rating system, then the user 8 will have the opportunity to amend the entered information 27. The user 8 may provide project metrics, such as site area, occupant, and parking space, to be able to confirm that credit compliance is being obtained.

The next step is to calculate cost impact 32. In particular, this step calculates the additional cost that the project will incur in term of first cost of the construction, such as additional subcontractor scope, materials, labor, and supervision. Also, the calculator of this step assesses the design related cost impact like architectural design work, engineering and modeling work, and consulting work in addition to the first cost.

Following this step, the benefits of the construction projects 38 are determined. This allows the project creator to review the monthly or yearly saving earned by the project. Each benefit will have a pre-defined annual percentage growth rate, which is defined by the user 8, to allow for inflation in the cost, and therefore a growth in the saving value of the construction project.

Once the benefits and costs have been determined, the central processing system 100 will be able to prepare reports 43, 44 and summaries for the user 8 to view, as illustrated in FIGS. 11 and 12. The following summaries may be created: credit cost summary, credit benefit summary, credit impact summary, and credit status summary.

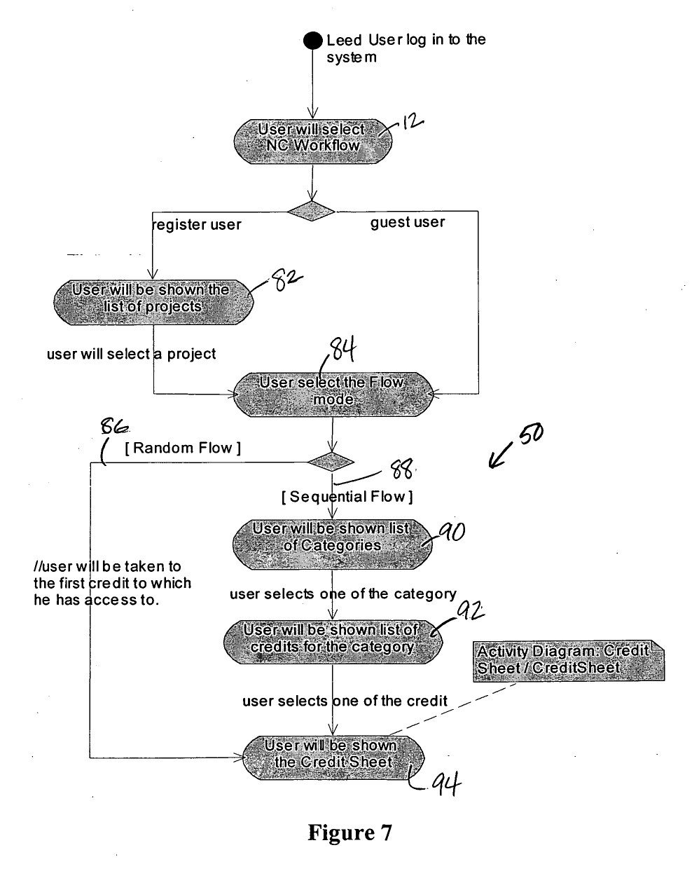

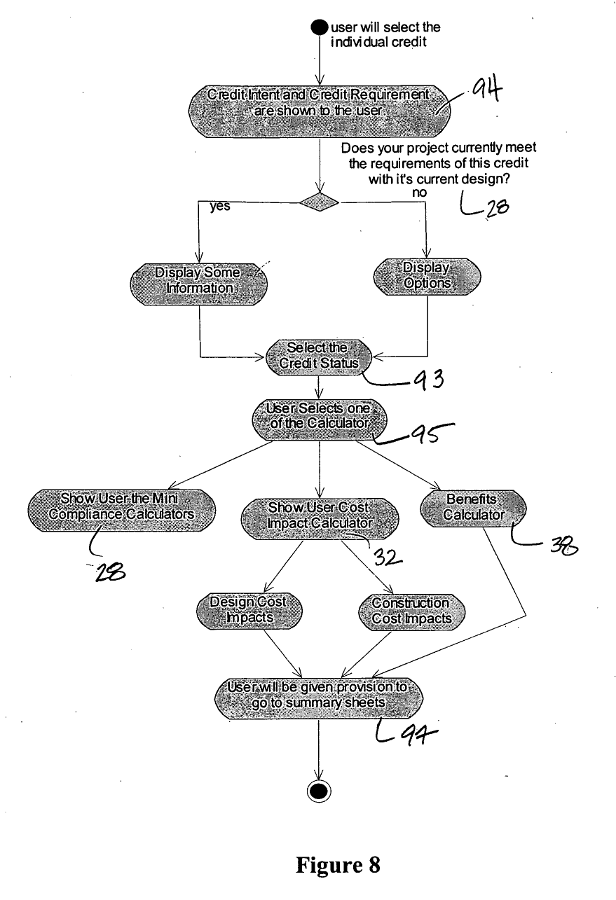

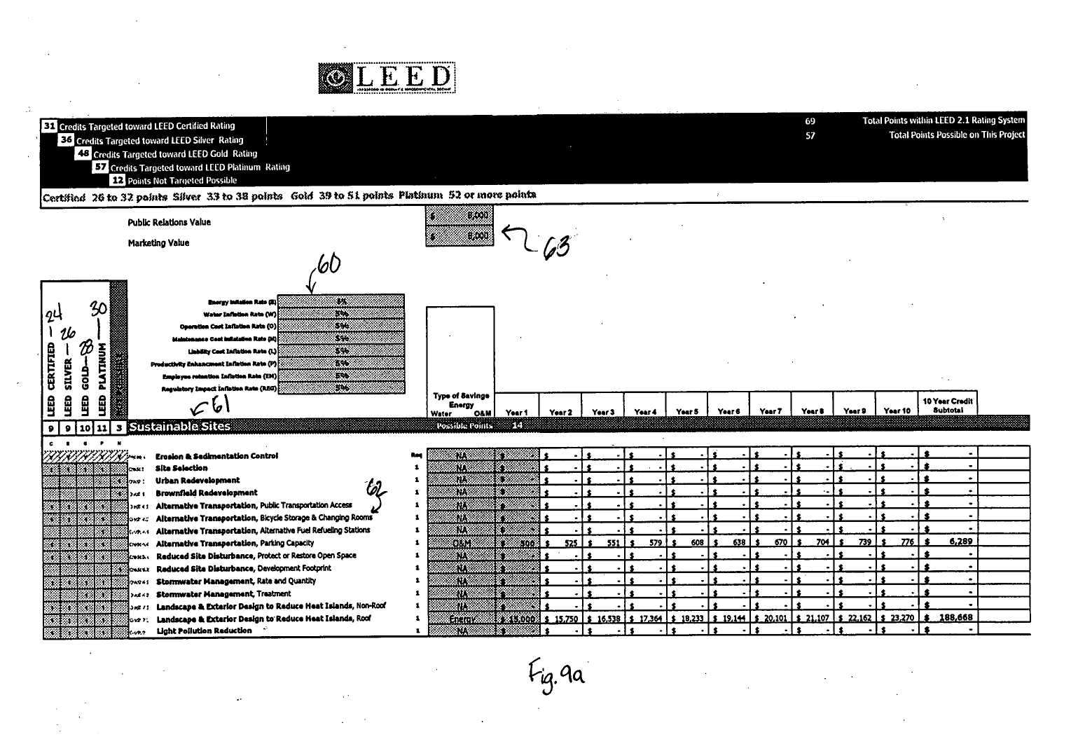

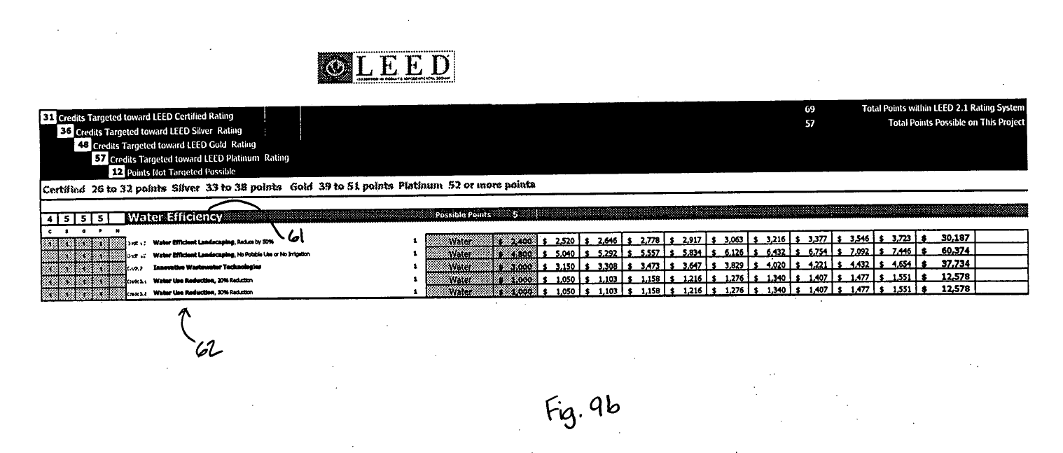

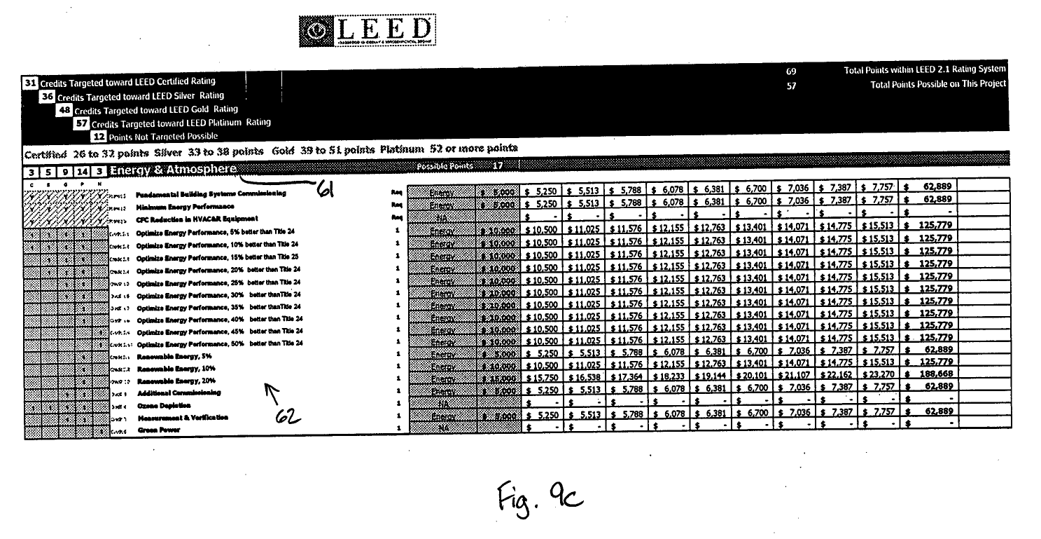

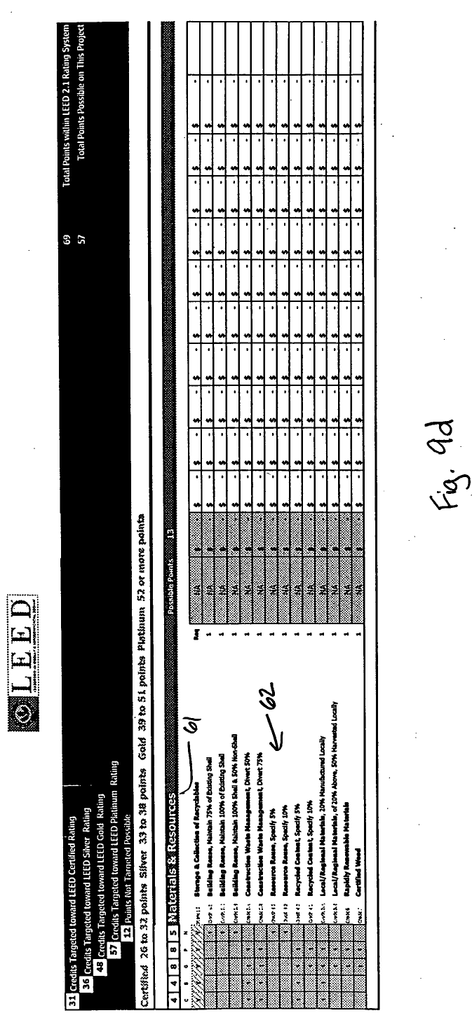

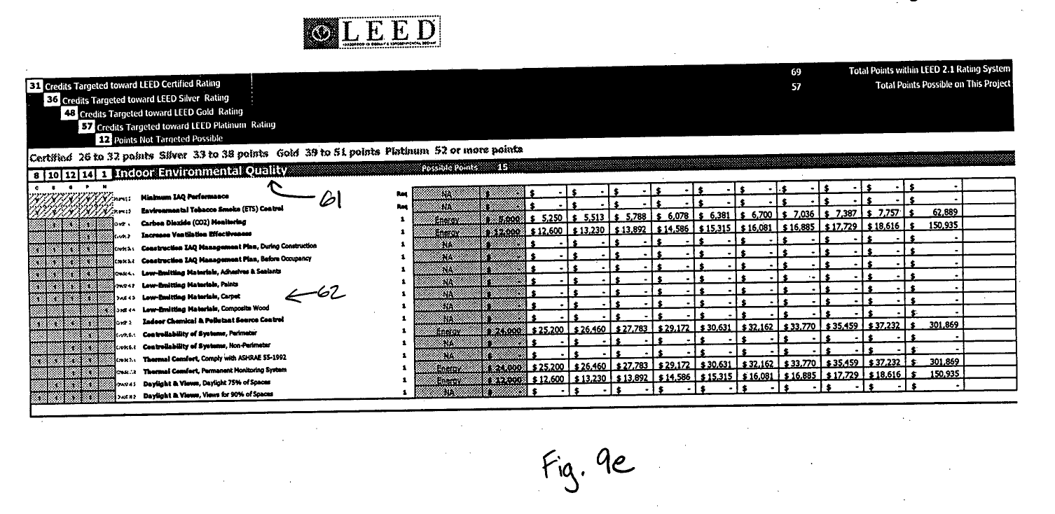

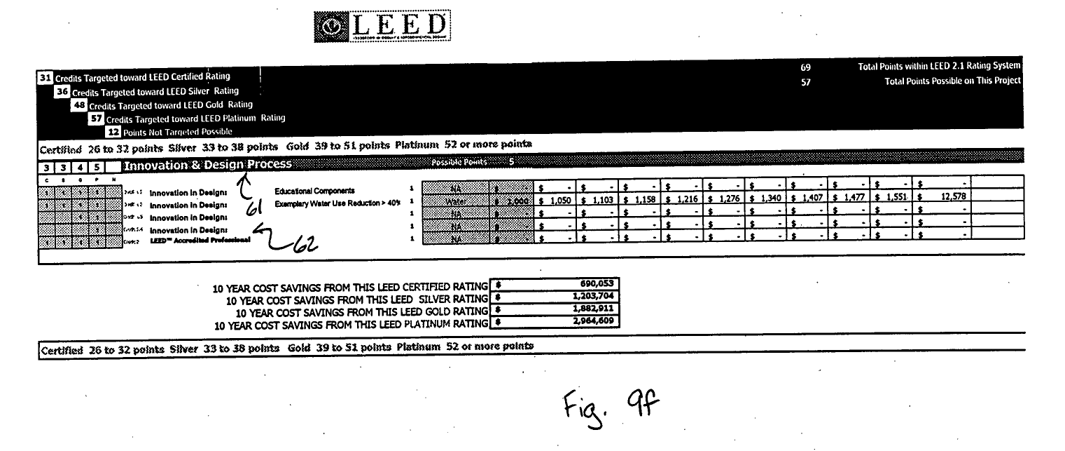

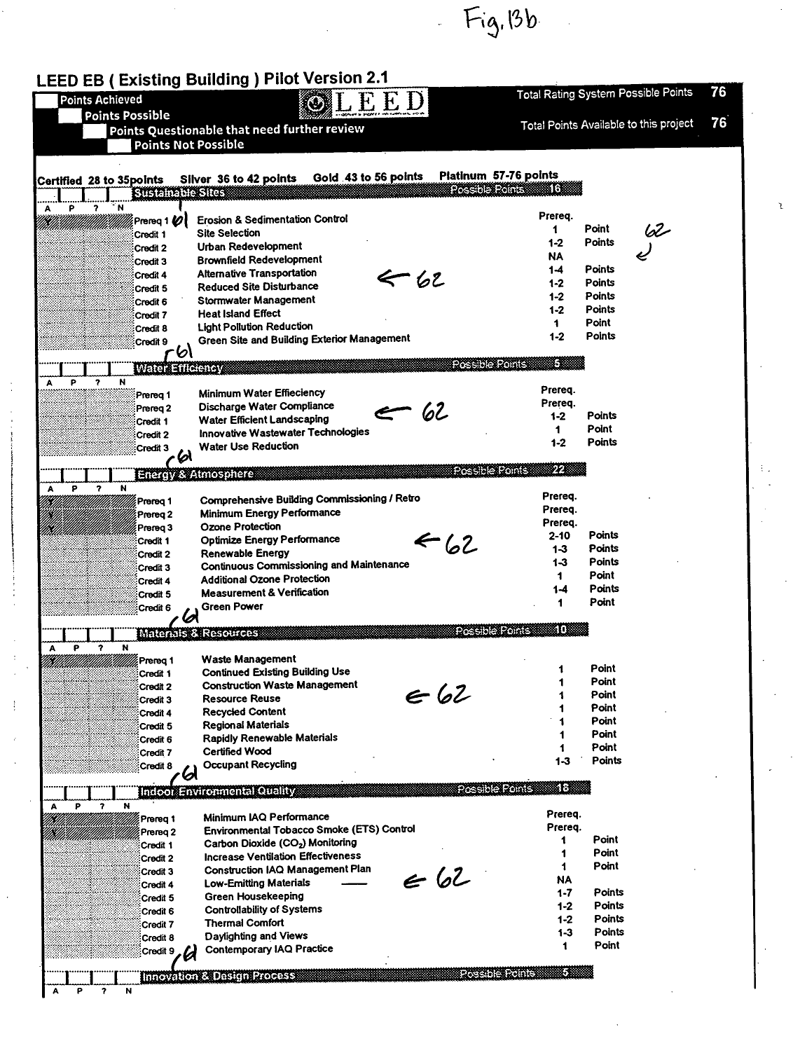

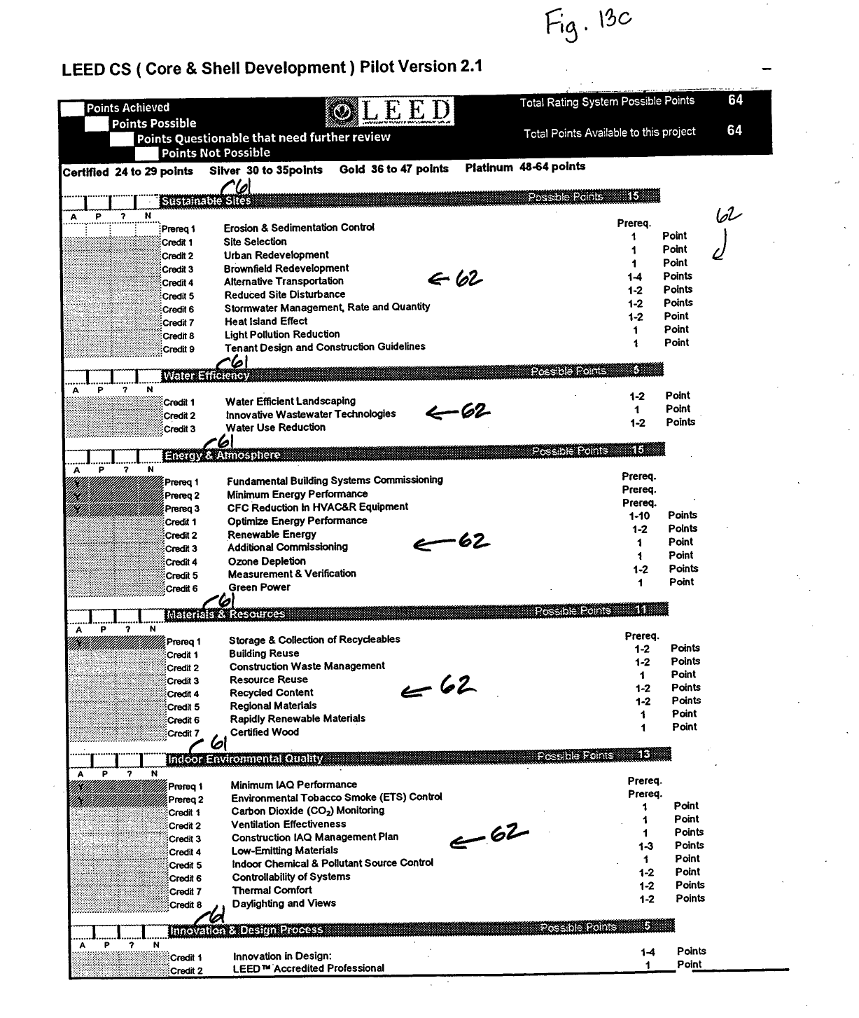

Referring now to FIGS. 7 and 8, more details are provided concerning the method of the present invention and the project evaluation step 50. As noted, the method of the present invention begins when the user 8 selects the new construction workflow. The system 100 retrieves the list of projects from the database 112 and displays the projects to the user 8 in step 82. The user 8 then selects a project and selects a flow mode 84, that is, whether to follow a sequential flow 86 or a random flow 88. If random flow 86 is selected, the system 100 retrieves the list of categories 61 to display to the user 8 from the database 112 (as illustrated in FIGS. 10a-10f), and the user 8 selects one of the categories 61. The system 100 shows the credits 62 for the particular category 61, and the user 8 selects a credit 62 and submits request. The system 100 displays the credit sheet (similar to that illustrated in FIGS. 9a-9f, 10a-10f, or 13a-13d). If the sequential flow 88 is selected, the credit sheets to which the user 8 has access to will be shown in the sequential order to assist the user 8. The user 8 can cancel the random/sequential flow 86, 88 from any point and go to home page. The unsaved data will be lost; although the user 8 will have an option to save the data and exit.

The system 100 will then display the credit intent and credit requirement for the specific credit. The user 8 will enter the credit status from the following list: Targeted, Possible, or Not Targeted. The user 8 will choose Yes/No based on “Project currently meets the requirements”. If the user 8 chooses “Yes”, then the system 100 displays the necessary information. If the user 8 chooses “No”, then the system 100 displays the possible options for the project to meet the credit requirements. The user 8 will then select one of the following processes to make the desired calculations: a compliance calculator 28, a cost impact calculator 32, or a benefits calculator 38. Once the calculations have been made, the system 100 will provide options to view the following summaries: Credit Cost Summary, Credit Benefit Summary, Credit Impact Summary, or Credit Status Summary.

With the step of calculating compliance 22, the calculation is based on the LEED formula for each. The intent is to help the user 8 make decisions for the current task at hand, with the page to be worked shown in context and easily referenced. The process starts with the system 100 displaying a list of credits 62 for a specific type of construction (see FIGS. 13a-13d), and the user 8 will select one of the credits from the list. The system 100 will then display the calculator or credit sheet for the chosen credit 62. The following are examples of computations that may be performed according to the user's choices as illustrated in FIG. 9a. For example, if the user 8 selects “Alternative Transportation—Bicycle Transportation” credit 70, the system 100 will display the following information to the user 8 to enter: Full Time Building Employees, Worker Hours, and User 8 enter the values that are required. The user 8 will submit this information, and the system 100 then calculates the following values using the formulae:
Full Time Employees=Worker Hours/8;
Secure Bicycle Spaces (Non-resident building)=Full Time Building Employees*5%;
Secure Bicycle Spaces (Resident building)=Full Time Building Employees*15%; and
Showering Facilities (Non-resident building)=Bicycle Spaces (Non-resident building)/8.
Using the information inputted by the user 8, the system 100 is able to determine the cost/benefit following this process.

If the user 8 selects “Alternative Transportation—Alternative Fuel Vehicles” credit, the user 8 selects any one of the Options and the system 100 calculates the values using the formulae.
Option I—Provide Alternative Fuel Vehicles
   Number of Alternative Fuel Vehicles that need to be provided to building occupants=Full Time Building Employees*3%
Option II—Provide Alternative Fuel refueling Stations
   User 8 enters the Vehicle Parking Capacity and system 100 will calculates the following
      Number of Alternative Fuel Refueling Stations=Vehicle Parking Capacity*3%

If the user 8 selects “Alternative Transportation—Parking Capacity” credit, then the user 8 selects any one of the options and the system 100 calculates the values using the formulae.
Option I—Size Parking to meet, but not exceed local zoning requirements
   Input—Number of Parking Spots required by local zone and Number of Parking spots provided by project.
      Number of required preferred Parking Spot=Number of Parking Spots*5%
Option II—New parking for rehabilitation projects
   Number of required preferred Parking Spot=Number of Parking Spots*5%

If the user 8 selects “Reduced Site Disturbance: Development Footprint” credit, then the user 8 selects any one of the options and the system 100 calculates the values using the formulae
Option I—Areas with zoning requirements
   Input—Local Zoning open space.
      Area of open space=Local Zoning open space*1.25
Option II—Areas without local zoning requirements
   Input—Development Footprint of project space.
   Area adjacent to building=Development Footprint of project

If the user 8 selects “Heat Island Effect: Non Roof” credit, then the system 100 requests that the user 8 to enter the following information: the area of site's non-roof impervious surfaces. If the user 8 selects any one of the options and the system 100 calculates the values using the formulae
Option I—Provide shade for the site's non-roof impervious surfaces
   Input—Area of shade, Area of light-colored/high and Area of open grid pavement Subtotal=Area of shade+Area of light-colored/high+Area of open grid pavement
   System 100 will compare this subtotal with the 30% of Area of site's non-roof impervious surfaces to meet the requirement or not.
Option II—Underground or covered by structured parking
   Input—Number of parking spaces
      Parking spaces that need=Number of parking spaces*50%
Option III—Open Grid pavement system
   Input—Parking Lot Area
      Open Grid Parking Lot Area required=Parking Lot Area*50%

If the user 8 selects “Heat Island Effect: Roof” credit, then the system 100 requests that the user 8 enter the area of roofing material.
Option I—Energy Star compliant and High emissive roofing
   Energy Star compliant & High emissive roofing=Area of Roofing Material*75%
Option II—Use Green (vegetated) roof
   Amount of Green required=Area of Roofing Material*50%
   If the user 8 selects “Energy & Atmosphere: Renewable Energy: 5%”, then the system 100 requests the total energy use expressed. The system 100 will then calculate the value using the formula:
   Supply of on-site renewable energy=Total energy use expressed*5%.
   If the user 8 selects “Energy & Atmosphere: Renewable Energy: 10%”, then the system 100 will calculate the value using the formula:
   Supply of on-site renewable energy=Total energy use expressed*10%
   If the user 8 selects “Energy & Atmosphere: Renewable Energy: 20%”, then the system 100 will calculate the value using the formula:
   Supply of on-site renewable energy=Total energy use expressed*20%

If the user 8 selects “Green Power”, then the system 100 will request the total building electricity consumption (over a one-year period). The system 100 will then calculate values using the formulae
2-year electricity consumption=Total Building electricity consumption*2
Amount of building electricity required=2-year electricity consumption*50%
Amount required for 100% and possible innovation credit=2-year electricity consumption

If the user 8 selects “Construction Waste Management—Divert 50% of Landfill” credit, then the system 100 will prompt the user 8 to enter the amount of estimated waste generated on-site. The system 100 will then calculate values using the formulae
Amount of estimated waste=Amount of estimated waste generated on-site*5%
If the user 8 selects “Construction Waste Management—Divert 75% of Landfill” credit, the system 100 will then calculate values using the formulae
Amount of estimated waste=Amount of estimated waste generated on-site*75%

If the user 8 selects “Resource Reuse—5%” credit, then the system 100 will request the Total Project Budget from the user 8. The system 100 will then calculate values using the formulae
Estimated Material Cost=Total Project Budget*45%
Material cost required=Estimated Material Cost*5%
If the user 8 selects “Resource Reuse—10%” credit, the system 100 will then calculate values using the formulae
Material cost required=Estimated Material Cost*10%

If the user 8 selects “Recycled Content—5%” credit, then the system 100 will request the Total Project Budget from the user 8. Using this information, the system 100 will compute the material cost required as follows:
Estimated Material Cost=Total Project Budget*45%
Material cost required=Estimated Material Cost*5%
If the user 8 selects “Recycled Content—10%” credit, then the system 100 will compute the material cost required as follows:
Material cost required=Estimated Material Cost*10%
Similarly, if the user 8 selects “Regional Materials: 20% Manufactured Regionally” credit, then the system 100 will compute the material cost required as follows:
Material cost required=Estimated Material Cost*20%
Moreover, if the user 8 selects “Regional Materials: 50% Manufactured Regionally” credit, then the system 100 will compute the material cost required as follows:
Material cost required=Estimated Material Cost*50%

If the user 8 selects “Rapidly Renewable Materials: 5%” credit, then the system 100 will calculate the value of the material cost required using the formula
Material cost required=Estimated Material Cost*5%

If the user 8 selects “Certified Wood: 50% of wood” credit, then the system 100 will request the cost of wood-based materials and products from the user 8. The system 100 will then calculate values using the formulae
Material cost of FSC Certified=Cost of wood-based materials and products*50%

The next step is for the system 100 to calculate the cost impact. The system 100 will give the user 8 the opportunity to choose design cost impact or construction cost impact. If the user 8 selects design cost impact for the credit, the system 100 displays the design cost impact page. The user 8 will enter the quantity and unit cost for each of Architectural Design Work, Engineering Design Work and Consulting Design Work. The architectural design work subtotal, Engineering Design Work Subtotal, and Consulting Design Work Subtotal is then calculated as sum of subtotals of all members, and the calculations are saved into the database for further processing. If the user 8 chooses construction cost impact option, then the system 100 displays the construction cost impact information.

The user 8 enters the following inputs for construction cost: Credit Requirements; Quantity; Unit; Unit Cost. The subtotal is calculated as (Quantity*Unit Cost). The Construction Cost Impact Subtotal will be calculated as sum of all the sub totals. Calculated corresponding values and Sub totals are saved into the database for further processing.

The step of calculating benefits 38 is typically savings that are a result of achieving the respective credit or credits. Monthly or yearly value of the savings will be taken as inputs so that the value can be analyzed over the life cycle that the project owner would like to review. The basic flow of this process starts when the user 8 selects Calculate Benefits option. The system 100 then displays the benefits calculator page, where the user 8 enters the following inputs for cost benefits and submits the information: types of benefits, the monetary values of the benefits, and the unit (both monthly and yearly). The first year value is calculated as
First Year Value=Monetary Value of Benefit*Unit Cost
The system 100 will then store the benefits and their values into the database 112.

While these examples of calculations are certainly not exhaustive of the calculations performed in the process of present invention, they do illustrate how a user inputs information to be used by the system 100 to determine the costs and benefits of various choices.

The user 8 may then select the option of viewing the summary, in which case the following steps are followed. The system 100 will display the following summaries: Credit Cost Summary; Credit Impact Summary; Credit Benefit Summary; and Credit Status Summary. If the user 8 selects Credit Cost Summary, then the system 100 displays the following information for calculating the general cost of the project: Additional Architectural Design Cost; Additional Engineering Cost; Additional Consulting Cost; Additional Construction Management Cost; LEED Accredited Professional Consulting Fee; LEED Registration Costs (Paid to USGBC); LEED Certification Costs (Paid to USGBC); and LEED Cost Rebate (If Applicable). The system 100 will sub-total all the above input values and display to the user 8. The system 100 calculates the following cost impact information automatically, for each credit as follows. Cost Impact of additional credit related Architectural Design Work; Cost Impact of additional credit related Engineering & Modeling Work; Cost Impact of additional credit related Consulting Work; Construction First Cost. The system 100 will then save the General Costs and Comments for each credit into the database 112.

If the user 8 selects Credit Impact Summary, then the system 100 calculates the following credit impact information, for each credit. The first costs for Design/Engineering/Consulting related Credit Cost Impacts, the Construction related Credit First Cost Impacts, the Benefits Analysis—User 8 Determined Value based on input on Credit Benefits Summary. The system 100 gives provision to select one of the ratings applicable for each credit. If the user 8 selects the lowest rating, the other higher ratings are automatically selected. The system 100 calculates the total points applicable for each rating category wise. The system 100 calculates the Cost Increase for each rating, points achieved for each rating and average cost for each point. The system 100 will save the necessary information into the database 112.

If the user 8 selects Credit Benefit Summary, then the system 100 displays the inflation rates selected for each credit. The user 8 will enter the inflation rate value for each inflation rate, and assign inflation rates with a particular designation, such as a three-letter acronym, for identification. The system 100 will display the following information for each of the credit as retrieved from the calculators: Type of Savings; Year 1 Benefits Value (Subtotal of all yearly benefits subtotaled on LEED Credit Sheet); and Financial Value based on term of analysis and Cost Analysis (Subtotal from User 8 defined Analysis Length (years) and Type of financial Calculation requested. For example, ten-year Net Present Worth of Savings). The system 100 calculates the following benefits from the above values for Years 2-10 and displays the information. The system 100 also calculates and displays inflation rates for each of the levels defined by the LEED, and will save the necessary information into the database 112.

If the user 8 selects Credit Status Summary, the system 100 displays the following information: Points Achieved; Points Possible; Points Questionable; and Points Not Possible. All of this information is retrieved from the credit sheets and allows the user 8 to confirm that the desirable credit rating is achieved.

If the user 8 selects Credit Impact Summary, then the system 100 calculates the following credit impact information, for each credit (as illustrated in FIGS. 11a-11f): First Costs (including Design/Engineering/Consulting related Credit Cost Impacts 64 and Construction related Credit First Cost Impacts 66), and Benefits Analysis 68, which is a user 8 determined value based on input on Credit Benefits Summary. For example, the ten-year net value. The system 100 gives provision to select one of the ratings applicable for each credit. If the user 8 selects the lowest rating, the other higher ratings are automatically selected. The system 100 calculates the total points applicable for each rating category, as well as the Cost Increase for each rating, points achieved for each rating and average cost for each point, which is then saved into the database 112.

With this information, the system 100 is able to develop reports that help the user 8 understand the present and future benefits of the options chosen. In particular, the system 100 is able to generate the Cash Flow Position Report as illustrated in FIG. 11. This report will illustrate the return on investments for respective green credits, both at year) and at a later time (i.e., Year 10 or Year 20) for the user 8 to be able to quickly and efficiently determine the most valuable investment based on environmental-friendly based values.

In summary, the method for estimating the total costs to implement a green design for a construction project over a period of time, which is compared to the estimate of the benefits over a period of time from the construction project. The method of the present invention therefore allows the user 8 to determine the most cost effective option available for a constructing or servicing a building. Moreover, the process allows the user 8 to analyze all costs and benefits available for a particular green project to decide which green credits are most desirable. Moreover, the cash flow diagram will allow the user 8 to adjust various factors (such as inflation rates) to adjust the reports in the case of extraordinary circumstances.

Thus, although there have been described particular embodiments of the present invention of a new and useful METHOD FOR EVALUATING THE COSTS AND BENEFITS OF ENVIRONMENTAL CONSTRUCTION PROJECTS, it is not intended that such references be construed as limitations upon the scope of this invention except as set forth in the following claims.

1. A method for evaluating an environmentally-friendly construction project comprising the steps of:
a) establishing a construction rating system to be used in analyzing the construction project, said construction rating system having multiple certification levels corresponding to a number of credits, each said credit corresponding with a construction improvement for the construction project,
b) selecting particular credits corresponding with said construction improvements to be implemented with the construction project;
c) determining costs of the construction project according to said selected credits;
d) determining benefits of the construction project according to said selected credits;
e) comparing said costs of the construction project with said benefits of the construction project; and
f) selecting said construction improvements matching said desired certification levels of said construction rating system.

2. The method as described in claim 1 wherein step a) further comprises:
selecting a construction rating system according to the type of construction to be performed.

3. The method as described in claim 1 wherein step b) further comprises:
selecting particular credits from categories of work projects.

4. The method as described in claim 1 wherein step c) further comprises:
calculating an initial construction cost; and
design related cost.

5. The method as described in claim 1 wherein step d) further comprises:
calculating an initial benefit of the construction project; and
calculating the continuing benefit of the construction project during the lifetime of the construction project.

6. The method as described in claim 1 wherein after step e) further comprising the step of:
generating a chart illustrating the combination of said costs of the construction project with said benefits of the construction process over the expected life of the construction project.

7. The method as described in claim 6, further comprising the step of generating a flow chart including results of each certification level.

8. A method for evaluating an environmentally-friendly construction project comprising the steps of:
a) establishing a construction rating system on a central processing unit to be used in analyzing the construction project, said construction rating system having multiple certification levels corresponding to a number of credits, each said credit corresponding with a construction improvement for the construction project, each construction improvement having a financial cost and a financial benefit,
b) selecting particular credits corresponding with said construction improvements to be implemented with the construction project;
c) comparing said financial costs of the construction improvement with said financial benefits of the construction project; and
d) selecting said construction improvements matching said desired certification levels of said construction rating system.
